(19) United States
(12) Patent Application Publication
(10) Pub. No.: US 2007/0276993 A1
(43) Pub. Date: Nov. 29, 2007

(54) Disk unit and reading ahead control method for rotation type storage device

(75) Inventor: Yukie Hiratsuka, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Techologies Netherlands B.V., Amsterdam (NL)

(21) Appl. No.: 11/801,684

(22) Filed: May 9, 2007

(30) Foreign Application Priority Data
May 9, 2006 (JP) 2006-130053

(51) Int. Cl. G06F 12/00

(52) U.S. Cl. 711/112

(57) ABSTRACT

Embodiments in accordance with the present invention increase a hit ratio of cache by deciding an access area for reading ahead using a latency time based on the feature of an access pattern. A disk unit comprises preceding data reading ahead means for reading the preceding data of read request data, succeeding data reading ahead means for reading ahead the succeeding data of read request data, and means for extracting the feature of the access pattern by monitoring the command. If it is required for the succeeding command to transfer read request data to the cache memory during the read-ahead execution of the succeeding data reading ahead means, a latency time that occurs in accessing the read request data for the succeeding command is predicted, and the predicted latency time is allotted to the succeeding data reading ahead means during execution and the preceding data reading ahead means for the read request data for the succeeding command, based on the feature of an access pattern in a command group immediately before receiving the succeeding command.

### CROSS-REFERENCE TO RELATED APPLICATION

The instant nonprovisional patent application claims priority to Japanese Patent Application No. 2006-130053 filed May 9, 2006 and incorporated by reference herein in its entirety for all purposes.

### BACKGROUND OF THE INVENTION

A disk unit is provided with a cache memory, in which data on the disk is transferred to the cache memory and managed, and data can be directly transferred from the cache memory to the host, thereby increasing the data transfer efficiency to the host. Further, data that is required in the succeeding command at high possibility is transferred to the cache memory, employing an overhead time of the host and a latency time, thereby increasing the data transfer efficiency. In this manner, the control for transferring data other than the host request data to the cache memory using an idle time is called a read-ahead control.

For example, in the read-ahead control using the latency time, if a read command received while reading ahead becomes cache miss, the latency time is firstly allotted to reading ahead the preceding data for the succeeding command (the upper limit is set to the amount of reading ahead the preceding data), and if it is predicted that the latency also occurs after reading ahead the preceding data for the succeeding command, the remaining predicted latency time is allotted to reading ahead the succeeding data for the preceding command. With this control, the latency time that occurs can be allotted to the read-ahead efficiently. Such a read-ahead control is described in patent document 1.

FIG. 16 shows a flow of the read-ahead control that is performed when the read command received while reading ahead becomes cache miss, as described in patent document 1. Also, FIG. 17 shows an operation example of the read-ahead control using the latency time. In FIG. 16, if the read command received while reading ahead becomes cache miss, it is checked whether or not the latency occurs (step 601). If the latency occurs, the latency time of predetermined length is allotted to reading ahead the preceding data for the succeeding command with cache miss (step 602). If it is predicted that the latency occurs even after the latency time is allotted to reading ahead the preceding data for the succeeding command (step 603), the remaining latency time is allotted to reading ahead the succeeding data for the preceding command (step 604).

In FIG. 17, the cache miss occurs in the read command R2 (702) received during the execution of reading ahead the succeeding data for the read command R1 (701) using the host overhead, and the latency time that occurs at this time is allotted to reading ahead the succeeding data for R1 (701) and reading ahead the preceding data for R2 (702). The open arrow in the drawing indicates the latency time that occurs when interrupting the R1 (701) while reading ahead and at once accessing the target track where R2 (702) exists immediately after R2 (702) becomes cache miss.

In the example of FIG. 17, when the seek is made immediately after the R2 (702) becomes cache miss, the head is placed at the position beyond the target data (703). Therefore, the latency (704) from a touchdown point 703 to the track end and the latency (705) from the top of target track to the target data occur. This latency time is obtained in advance by a controller, a predetermined time (706) is firstly allotted to reading ahead the preceding data for the succeeding command, and if it is predicted that the latency time still occurs even after allotting the predetermined time, the remaining latency time is allotted to reading ahead the succeeding data for the preceding command R1 (701). In this manner, successive data over R1 (701) and R2 (702) can be read out efficiently.

JP-A-2002-244816 (Patent document 1) relates to a disk device.

To increase the hit ratio of cache, it is necessary to read ahead data required in the succeeding command at high possibility. In the read-ahead control of patent document 1, though the amount of read-ahead made using the latency time is maximized, the data required in the succeeding read command at high possibility is not necessarily read ahead. Therefore, even with the access pattern of accessing continuously the near area (accessible area using the latency time: within Sectors Per Track), the hit ratio is not improved too greatly in some cases. Accordingly, in the read-ahead using the latency time, it is required to take measures for not only increasing the amount of read-ahead but also reading selectively the data required in the succeeding read command at high possibility.

### BRIEF SUMMARY OF THE INVENTION

Embodiments in accordance with the present invention increase a hit ratio of cache by deciding an access area for reading ahead using a latency time based on the feature of an access pattern. A disk unit comprises preceding data reading ahead means for reading the preceding data of read request data, succeeding data reading ahead means for reading ahead the succeeding data of read request data, and means for extracting the feature of the access pattern by monitoring the command. If it is required for the succeeding command to transfer read request data to the cache memory during the read-ahead execution of the succeeding data reading ahead means, a latency time that occurs in accessing the read request data for the succeeding command is predicted, and the predicted latency time is allotted to the succeeding data reading ahead means during execution and the preceding data reading ahead means for the read request data for the succeeding command, based on the feature of an access pattern in a command group immediately before receiving the succeeding command.

### BRIEF DESCRIPTION OF THE DRAWINGS

FIG. 1 is a flowchart showing the read-ahead control after determining the continuity of access pattern according to one embodiment of the present invention.

FIG. 2 is a block diagram showing a configuration example of a magnetic disk unit according to one embodiment of the invention.

FIG. 3 is a flowchart showing the control for switching the read-ahead control methods based on the presence or absence of an access pattern according to one embodiment of the invention.

FIG. 4 is a view showing an example of access pattern in which the read access is made in the minus direction and the access interval for each command is within a SPT distance.

FIG. 5 is a view showing an operation example where the access pattern of FIG. 4 is processed by the conventional read-ahead control.

FIG. 6 is a view showing an operation example where the access pattern of FIG. 4 is processed by the read-ahead control according to the embodiment.

FIG. 7 is a view showing an example of access pattern in which the read commands issued non-successively are accessed in the plus direction and the access interval for each command is within the SPT distance.

FIG. 8 is a view showing an operation example where the access pattern of FIG. 7 is processed by the conventional read-ahead control.

FIG. 9 is a view showing an operation example where the access pattern of FIG. 7 is processed by the read-ahead control according to the embodiment.

FIG. 10 is a flowchart showing a process for extracting the access pattern of FIGS. 4 and 7.

FIG. 11 is a view showing an example of access pattern in which there is directionality of access in the read commands and the access interval between non-successive commands is within a fixed distance.

FIG. 12 is a flowchart showing an example where the access pattern of FIG. 11 is processed by the read-ahead control according to an embodiment of the present invention.

FIG. 13 is a view showing one example of arrangement on the disk for the access pattern of FIG. 11 and an operation example where it is processed by the read-ahead control according to an embodiment of the present invention.

FIG. 14 is a flowchart showing a process for extracting the access pattern of FIG. 1 I.

FIG. 15 is a flowchart showing a process for judging the continuity of the access pattern of FIG. 11.

FIG. 16 is a flowchart showing the conventional read-ahead control using the latency.

FIG. 17 is a view showing an operation example where the read-ahead control of FIG. 16 is applied.

FIG. 18 is a flowchart showing a process for handling the access pattern under the read-ahead control with command queuing according to an embodiment of the present invention.

FIG. 19 is a view showing an example of access after extracting the pattern concerned that is extracted in FIG. 18.

FIG. 20 is a view showing an operation example where the access pattern of FIG. 18 is processed by the read-ahead control according to an embodiment of the present invention.

### DETAILED DESCRIPTION OF THE INVENTION

Embodiments in accordance with the present invention relate to a data transfer technique for transferring data on a disk to a cache memory efficiently to increase the hit ratio of cache and the data transfer rate.

In the light of the problem mentioned above, it is a first object of embodiments in accordance with the present invention to increase the hit ratio of cache by deciding the access area of read-ahead using the latency time by applying the feature of access pattern.

Also, it is a second object of embodiments in accordance with the present invention to extract the feature of access pattern by monitoring the pattern of command access.

In order to accomplish the above first object, a rotation type storage device represented by a disk unit of an embodiment of the present invention decides an access area for reading ahead using the latency time based on the feature of access pattern. That is, the typical disk unit of the invention has a disk, a head, a cache memory, in which if read request data is not stored in the cache memory, the read request data is read through the head from the disk and transferred to the cache memory, characterized by comprising preceding data reading ahead means for reading the data stored at an address before the read request data through the head from the disk and transferring it to the cache memory in a disk latency time taken for the head to access the read request data after the end of seeking to the track of the disk in which the read request data is stored, succeeding data reading ahead means for reading the data stored immediately after the read request data through the head from the disk and transferring it to the cache memory after transferring the read request data to the cache memory, latency time prediction means for predicting a latency time that occurs when the preceding data reading ahead means executes the read-ahead if it is required for the succeeding command to transfer the read request data to the cache memory while the succeeding data reading ahead means is executing the read-ahead, and means for allotting the predicted latency time to the succeeding data reading ahead means during execution and the preceding data reading ahead means for the read request data for the command based on the feature of an access pattern in a command group immediately before receiving the command.

Also, in order to accomplish the above second object, the disk unit according to an embodiment of the present invention is characterized in that the access pattern and its feature are extracted by analyzing an access direction and an access interval in terms of the logical block address (LBA) designated by the read command.

With embodiments of the invention, the access area for reading ahead using the latency time is decided based on the feature of the pattern for read access, whereby the hit ratio of cache can be improved, and the data transfer rate can be increased. Especially for the video, the reading process (rewind or fast-forward process) for the data written sequentially can be sped up.

Embodiments in accordance with the present invention will be described referring to the drawings below.

FIG. 2 is a block diagram showing a configuration example of a magnetic disk unit according to one embodiment of the invention. The magnetic disk unit (hereinafter a disk unit) comprises a program ROM 101 mounting a control program, a RAM 102 storing data inside a cache and a table for managing mainly data concerning a cache area, a Timer 103 for managing and setting the time inside the disk unit, a control processor 104, which builds in the ROM 101, the RAM 102 and the Timer 103, for reading and executing the control program on the ROM 101, a cache memory 105 for temporarily writing the read request data or write request data, a hard disk controller (HDC) 107 for controlling the data transfer between the host and the cache memory 105 and between the cache memory 105 and the magnetic disk (hereinafter disk) 106, a servo control circuit 108 for making the control to move a head to the designated position in performing the reading or writing of data, a voice coil motor (VCM) 109 for moving the head in accordance with an instruction of the servo control circuit 108, a motor driver 110 for controlling the rotation of disk, a selector 111 for selecting only a signal of the head designated from a magnetic signal read through the head, a signal processing circuit 112 for converting analog data sent from the selector 111 into digital data or converting digital data sent from the HDC 107 into analog data, a disk formatter 113 for transferring the read data sent from the signal processing circuit 111 to the cache memory 105 by opening or closing a reading gate or transferring the write data passed from the cache memory 105 to the signal processing circuit 112 by opening or closing a writing gate, and a host interface 114 for exchanging the command or data.

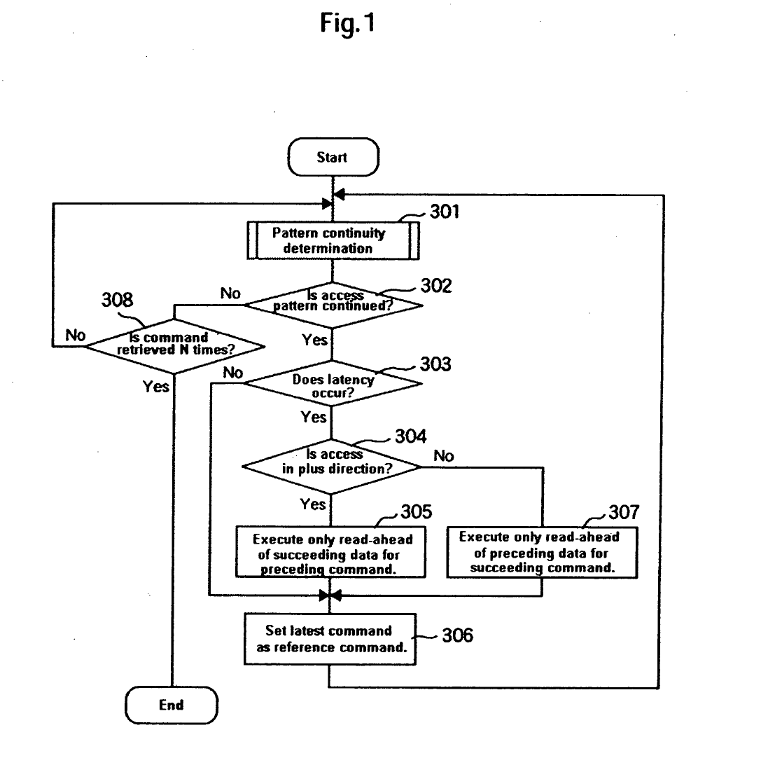

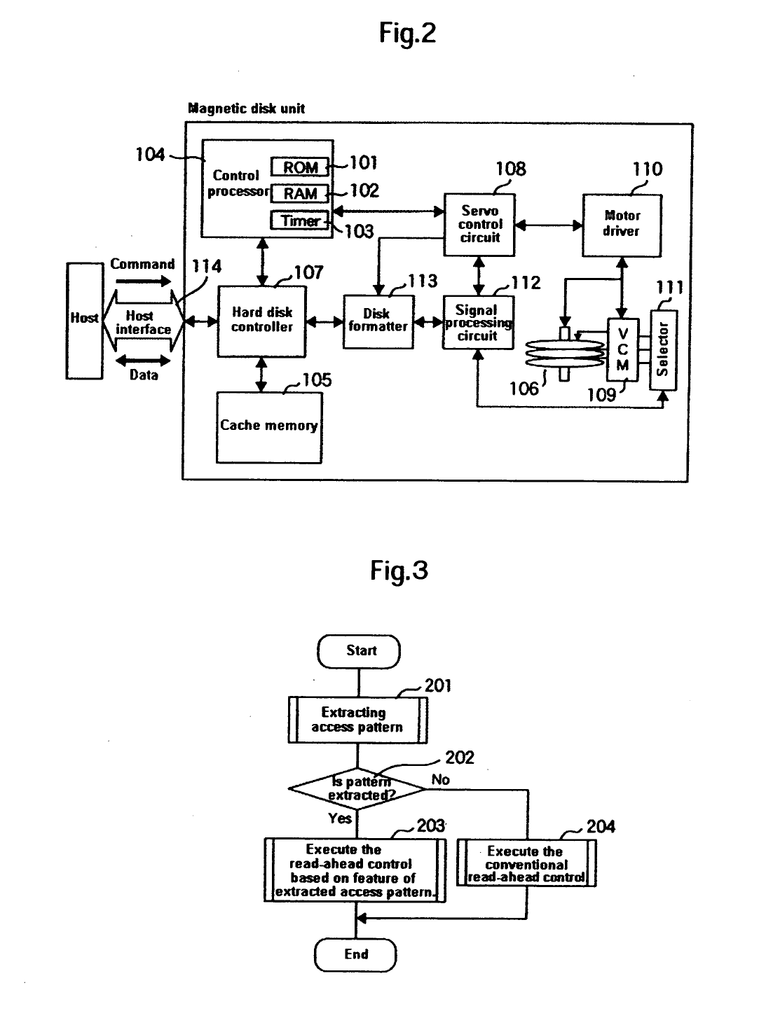

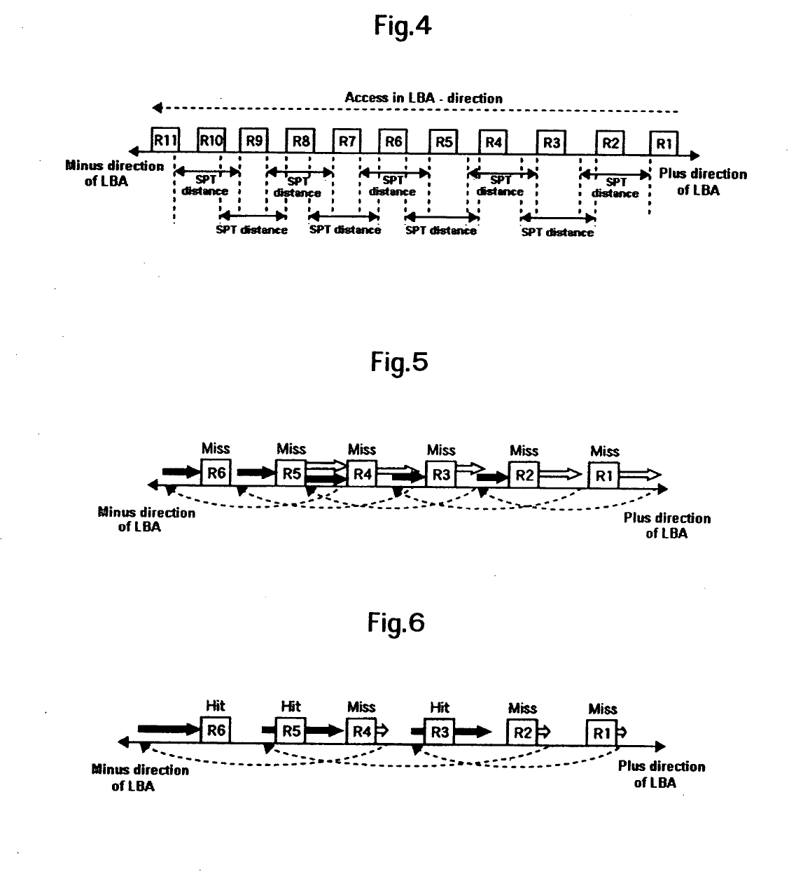

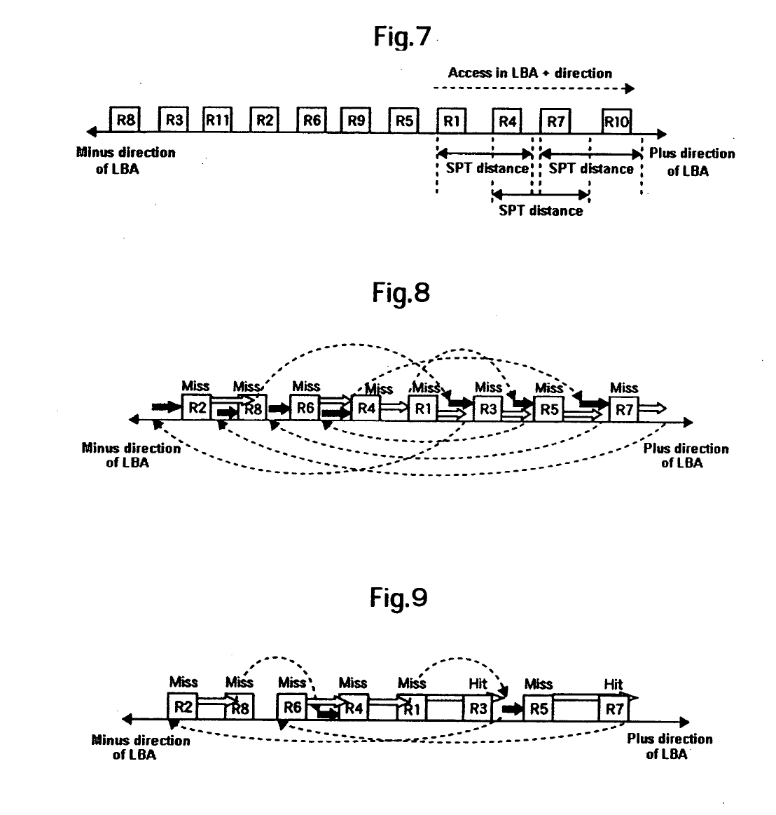

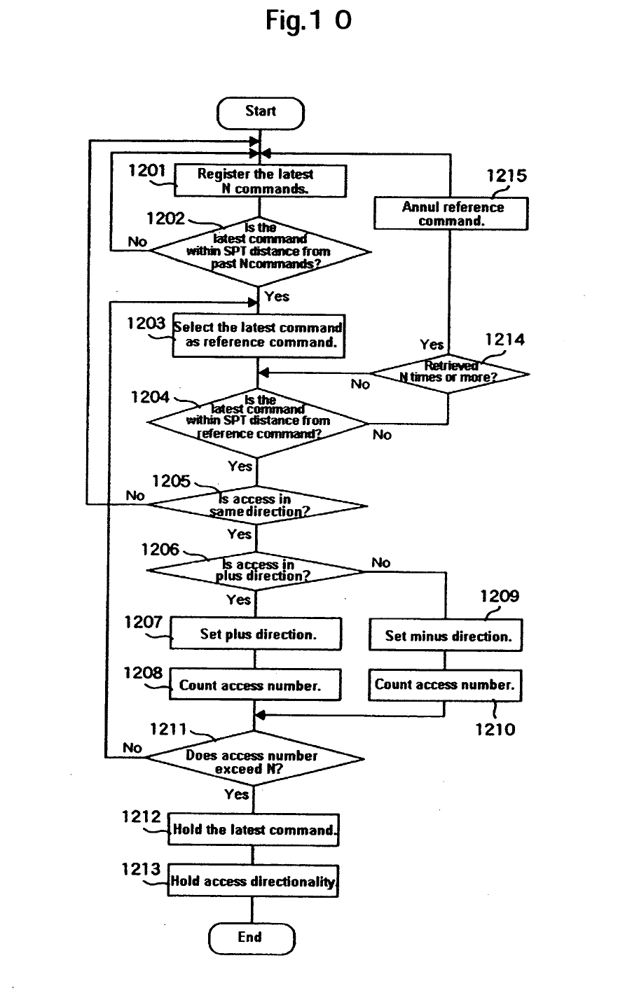

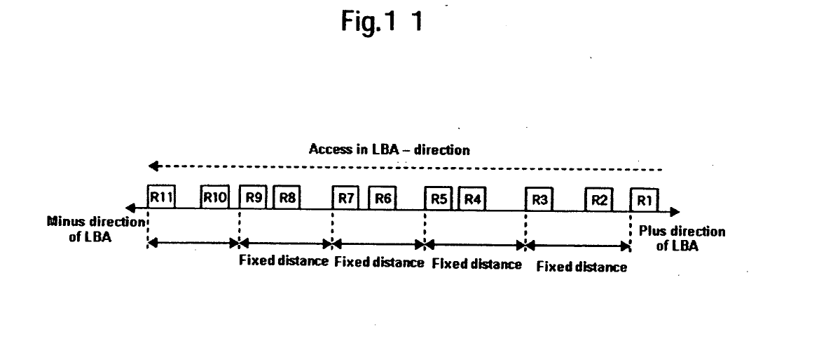

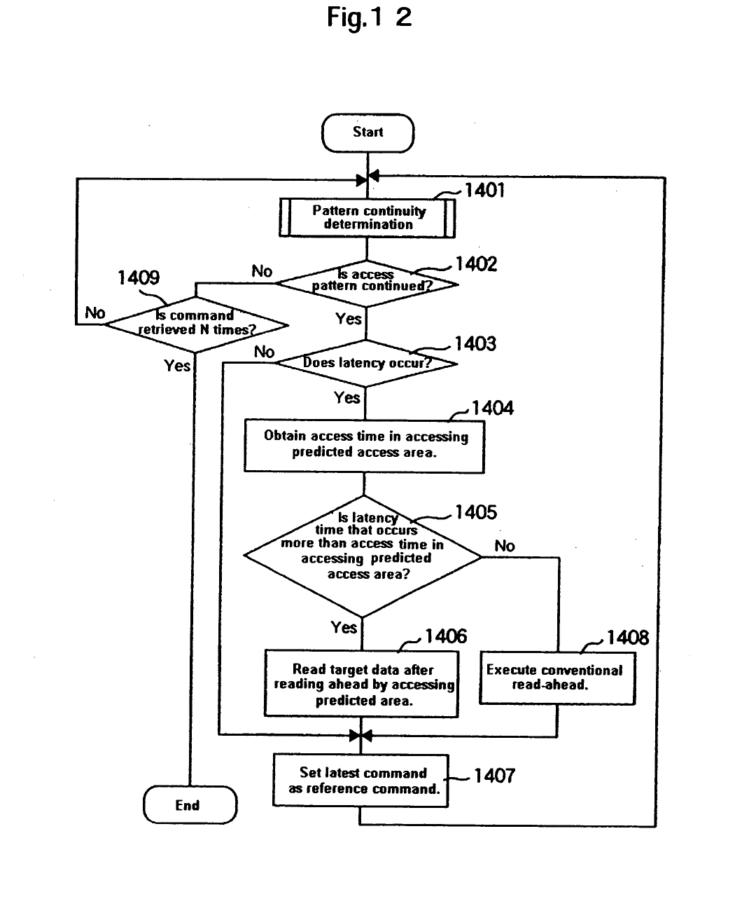

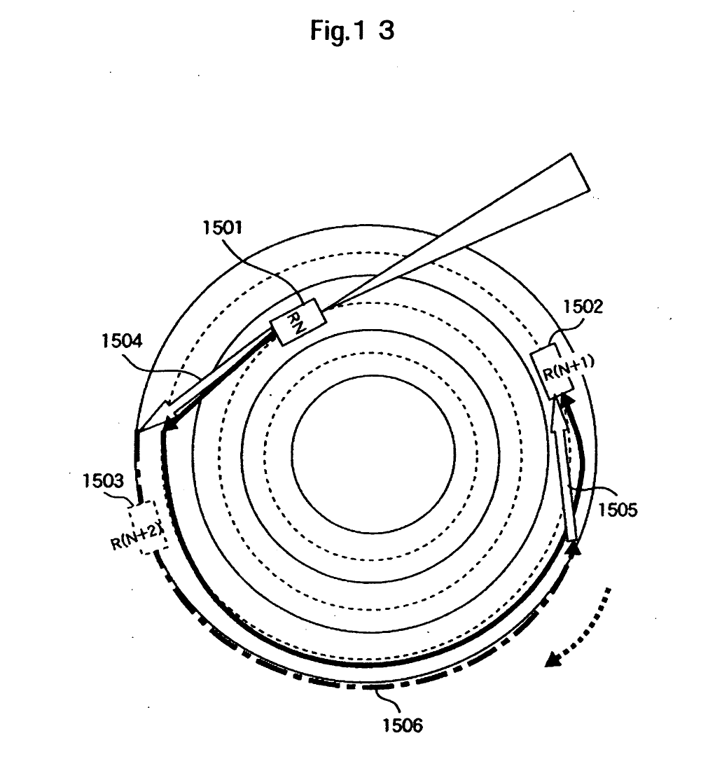

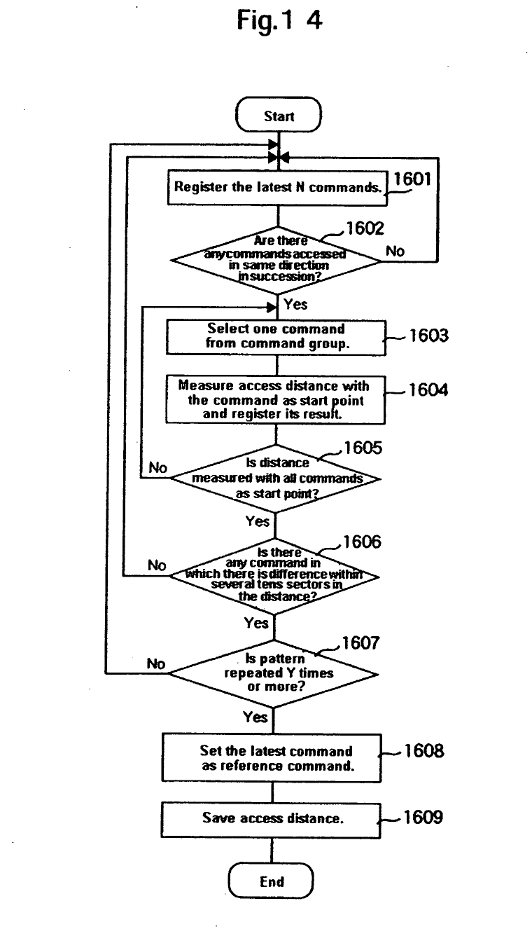

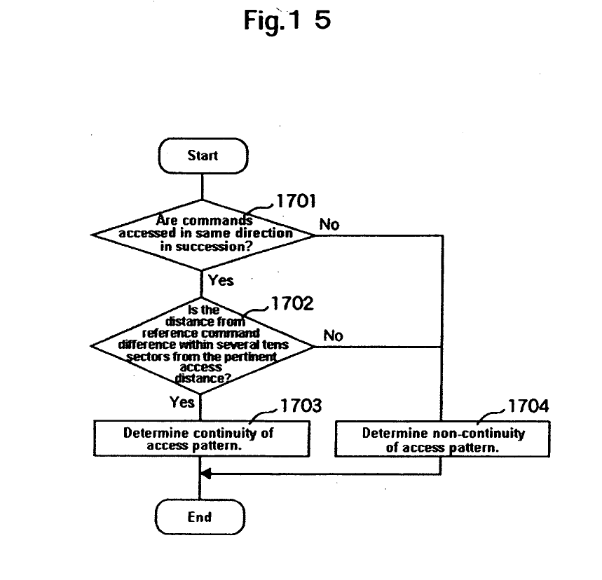

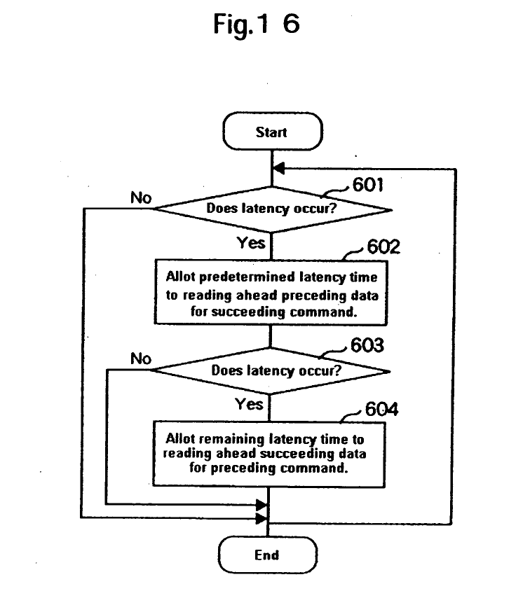

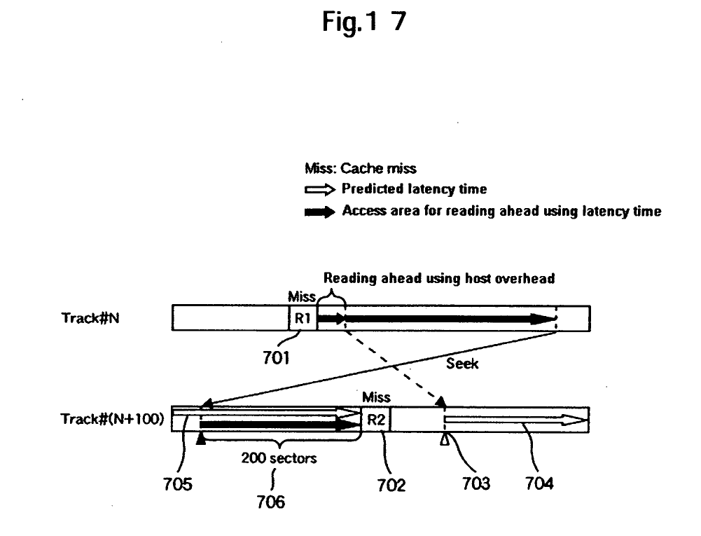

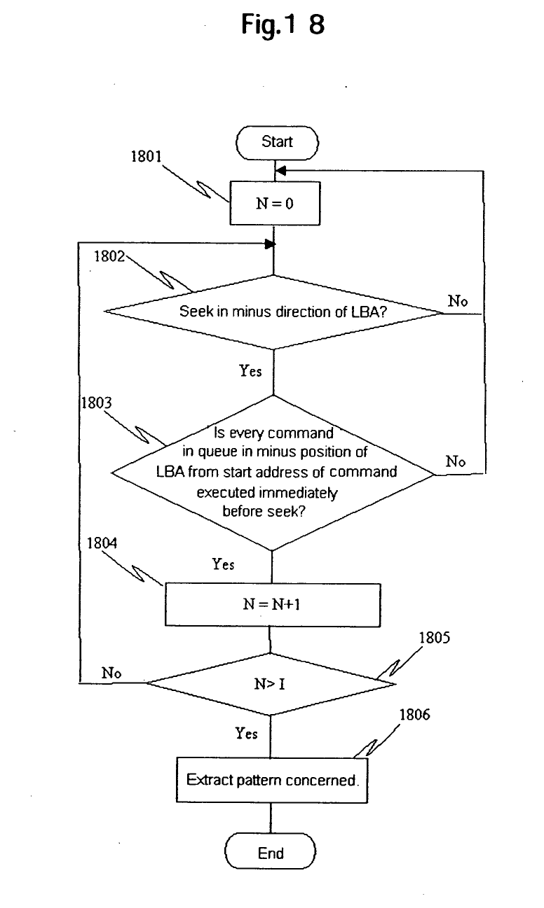

FIG. 3 shows a flow of the process for controlling the read-ahead using the latency time based on the feature of access pattern. The disk unit extracts an access pattern (step 201: see FIGS. 10 and 14 for the processing contents). If the pattern is extracted (step 202), the read-ahead control is performed according to the feature of extracted access pattern (step 203: see FIGS. 1 and 12 for the processing contents). If the access pattern is not extracted, the conventional read-ahead control is performed (step 204: see FIG. 16 for the processing contents). In this embodiment, the following process is performed by the control processor 104, but may be performed by any other control unit, for example, the HDC 107, than the control processor 104.

FIG. 1 shows a flowchart of the read-ahead control for the pattern with directionality in the access. If the disk unit receives a command, the continuity determination for the pattern with directionality in the access is made (step 301). The directionality of access is analyzed in terms of a logical block address (Logical Block Address (LBA)), and judged as the plus direction or minus direction by comparing the LBA. If the continuity is confirmed (step 302), it is checked whether or not any latency occurs in the command (step 303). If the latency occurs, it is checked whether or not the access is made in the plus direction (step 304). If the access is made in the plus direction, the succeeding data for the preceding command is only read ahead (step 305). Thereafter, the latest command is set as a reference command (step 306). The reference command means the command as the reference to judge the continuity of access pattern. Returning to step 304, it is checked whether or not the access direction is the plus direction. If the access direction is not the plus direction, the preceding data for the succeeding command is only read ahead (step 307).

Also, returning to step 302, if the continuity of access pattern is not confirmed, it is checked whether or not the command is retrieved N times (step 308). If the command is retrieved N times, the procedure is ended. Also, it is checked whether or not the command is retrieved N times (step 308), and if the command is not retrieved N times, a continuity determination process of pattern (step 301) is performed again.

FIG. 4 shows an example of read access in which the access has directionality. In the example of FIG. 4, the read commands R1 to R11 are issued in succession in the sequence of command number. For all of R1 to R11, the access is made in the minus direction of LBA, in which the read request data of each command is within a Sectors Per Track (SPT) distance from the read request data of the read command issued immediately before. The distance is analyzed as the distance between the start address of the read request data for the read command issued immediately before and the start address of the read request data for the command concerned.

FIG. 5 shows an example of read-ahead operation where the access pattern of FIG. 4 is performed by the conventional read-ahead control. In FIG. 5, the open arrow indicates the read-ahead for the succeeding data of the read request data, and the solid line arrow indicates the read-ahead for the preceding data of the read request data. Also, Miss indicates a cache miss (Cache miss), and the broken line arrow indicates the seek. In applying the conventional read-ahead control, the latency time that occurs when there is a cache miss with the pattern for making the read access in the minus direction of LBA in succession is allotted to reading ahead the preceding data of the read request data for the succeeding command where the cache miss occurs and reading ahead the succeeding data of the read request data for the preceding command. Since the latency time that occurs is allotted to reading ahead for two preceding and succeeding commands, the cache miss might occur frequently in some cases, even if the access distance between commands is within the SPT distance as shown in FIG. 4.

Thus, for the access pattern of FIG. 4, all the latency time is allotted to the reading ahead process with the same direction as the directionality of access, as shown in the control flow of FIG. 1. FIG. 6 shows an operation example where the access pattern of FIG. 4 is performed by the read-ahead control made on the disk unit according to this embodiment as described with reference to FIG. 1. The operation of FIG. 6 is the processing operation for the command received after extracting the access pattern of FIG. 4. The open arrow in FIG. 6 indicates the read-ahead for the succeeding data of the read request data, and the solid line arrow indicates the read-ahead for the preceding data of the read request data. Also, Miss indicates the cache miss (Cache miss), Hit indicates the cache hit (Cache hit), and the broken line arrow indicates the seek. A different point of the operation as shown in FIG. 5 from the conventional read-ahead control is that the latency time that occurs is allotted to only the read-ahead in the same direction as the directionality of access so that the amount of read-ahead in the same direction of access is increased. Therefore, the hit ratio of cache is increased in the succeeding command to access in the minus direction of LBA.

FIG. 7 shows another example of pattern with directionality in the access. In the example of FIG. 7, the read commands R1 to R11 are issued in succession in the sequence of command number. Though the R1, R4, R7 and R10 are not successive in the order of issuing the command, the access is made in the plus direction of LBA in the relationship of R1, R4, R7 and R10. Also, the distance of R1, R4, R7, R10 from the read request data for the directly previous read command is within the Sectors Per Track (SPT) distance. The distance is analyzed as the distance between the start address of the read request data for the read command issued immediately before and the start address of the read request data for the command concerned.

FIG. 8 shows an example of read-ahead operation where the access pattern of FIG. 7 is performed by the conventional read-ahead control. In the conventional read-ahead control using the latency, the latency time that occurs is allotted to reading ahead the succeeding data for the preceding command and reading ahead the preceding data for the succeeding command, as described with reference to FIGS. 16 and 17. In the conventional read-ahead control, when there is a cache miss with the pattern for making the read access in the plus direction of LBA in succession, the latency time that occurs is allotted to reading ahead the preceding data of the access data for the succeeding command where the cache miss occurs and reading ahead the succeeding data for the preceding command. Since the latency time that occurs is allotted to reading ahead for two preceding and succeeding commands, in the access pattern as shown in FIG. 7, the cache miss might occur frequently in some cases as shown in FIG. 8.

Thus, for the access pattern of FIG. 7, all the latency time is allotted to the read-ahead process with the same direction as the directionality of access, as shown in the control flow of FIG. 1. FIG. 9 shows an operation example where the access pattern of FIG. 7 is performed by the read-ahead control made on the disk unit according to this embodiment as described with reference to FIG. 1. The open arrow in FIG. 9 indicates the read-ahead for the succeeding data of the read request data, and the solid line arrow indicates the read-ahead for the preceding data of the read request data. Also, Miss indicates the cache miss (Cache miss), Hit indicates the cache hit (Cache hit), and the broken line arrow indicates the seek. The operation of FIG. 9 is the operation in the command received after extracting the access pattern of FIG. 9. A different point of the operation as shown in FIG. 8 from the conventional read-ahead control is that the latency time that occurs is allotted to only the read-ahead in the same direction as the direction of access so that the amount of read-ahead in the direction of access pattern is increased. Therefore, when the pattern for accessing in the plus direction of LBA as shown in FIG. 7 is continued, the hit ratio of cache is increased.

With this embodiment as described above, the access area of read-ahead using the latency time is decided based on the feature of pattern in the read access, whereby the hit ratio of cache can be improved, and the data transfer rate can be increased. Especially for the video, a reading process (rewind or fast-forward process) for the data written sequentially can be sped up.

Referring to FIG. 10, the control for extracting the pattern with directionality in the access as shown in FIG. 4 or 7 will be described below. It is supposed that the control flow of FIG. 10 treats the read command only. The access information of the latest N commands is registered (step 1201). The access information is the access start address (start address of read request data) indicated by the LBA set up for each command. In the following, it is supposed that the directionality of access and the access interval are judged based on the access start address indicated by the LBA. If the LBA of the access start address is increased in the order of issuing the command, it is judged that the access direction is the plus direction, or if the LBA of the access start address is decreased in the order of issuing the command, it is judged that the access direction is the minus direction. Also, the access interval is obtained as the distance of the access start address for each command.

After the latest N commands are registered (step 1201), if the new command is received, it is examined whether or not the latest command is within the SPT distance from the past N commands (step 1202). If the latest command is within the SPT distance from the access start address (LBA) of the latest N commands in the past, this latest command is selected as the reference command (step 1203). Then, it is examined whether or not the next received latest command is within the SPT distance from the reference command (step 1204). If the latest command is within the SPT distance, it is examined whether or not the received latest command is to access in the same LBA direction as the reference command (step 1205). If in the same direction, it is examined whether or not the access is made in the plus direction (step 1206). If the access is made in the plus direction, a flag of the plus direction is set (step 1207), and the access number in the plus direction is incremented by one (step 1208). Returning to step 1206, it is examined whether or not the access is made in the plus direction. If the access is not made in the plus direction, a flag of the minus direction is set (step 1209), and the access number in the minus direction is incremented by one (step 1210).

After the access number in the plus or minus direction is counted, it is examined whether or not the counted access number exceeds T (step 1211). As a result, if T is exceeded, the procedure is ended with the latest command and the extracted directionality of access held (steps 1212 and 1213).

Returning to step 1204, it is examined whether or not the latest command is within the SPT distance from the reference command. If the latest command is not within the SPT distance, it is examined whether or not the command is retrieved N times or more (step S1214). If the command is not retrieved N times, the procedure returns to step 1204. It is examined whether or not the command is retrieved N times or more, and if the command is retrieved N times or more, the information of the reference command is annulled (step 1215), and the procedure returns to step 1201. At step 1202, if the received command is not in the relation within the SPT distance from the past N commands after the latest N commands are registered, the procedure returns to step 1201. The pattern with directionality of access can be extracted by performing the above process.

FIG. 11 shows another example of read access with directionality of access. In the example of FIG. 11, the read commands R1 to R11 are issued in succession in the sequence of command number. For all of R1 to R11, the access is made in succession in the minus direction of LBA, and the access intervals between commands R1 and R3, R3 and R5, R5 and R7, R7 and R9, and R9 and R11 are the fixed distance from the read command issued two before. This access feature is that the access is made in the same direction in succession and commands are accessed regularly with the fixed distance interval between every other command. The fixed distance means the distance having the width of several tens sectors.

FIG. 12 shows a control flow for the access pattern of FIG. 11. The control flow of FIG. 12 is a process after extracting the pattern of FIG. 11. If the pattern has regularity in the directionality of access and the access interval, like the pattern of FIG. 11, an area to be accessed by the subsequent command can be predicted to some extent. Therefore, it is possible to make the read-ahead while predicting the area to be accessed by the subsequent command, using the feature of its access pattern. First of all, the continuity determination for the access pattern of FIG. 11 is made (step 1401: see FIG. 15 for the processing contents). The continuity of the access pattern is confirmed (step 1402). If the continuity of the access pattern is confirmed, it is examined whether or not any latency occurs in the received command (step 1403). If it is judged that the latency occurs, the access time in accessing the predicted access area is obtained (step 1404). This access time means the time taken from accessing the predicted access area from the current position of the head to accessing the target data of the received command.

FIG. 13 shows an example of data arrangement on the disk for the read data in the access pattern as shown in FIG. 11. In the example of FIG. 13, the commands RN(1501) and R(N+1)(1502) are issued. When the command of RN(1501) is received, the area to be accessed by R(N+2)(1503) can be predicted with the feature of the access pattern as shown in FIG. 11. Therefore, when the R(N+1)(1502) is received, the time for accessing the access predicted area of R(N+2)(1503) from the current head, and further accessing the R(N+1)(1502) (a total of two seek times (seek 1504 and seek 1505) and the latency time (1506)) can be also calculated.

Returning to FIG. 12, it is examined whether or not the latency time that occurs is greater than the access time in accessing the predicted access area (step 1405). If so, the target data is read after reading ahead by accessing the predicted area (step 1406). Thereafter, the latest command is set as the reference command (1407). Also, if the latency time that occurs is less than or equal to the access time in accessing the predicted access area, the conventional read-ahead is performed (step 1408), and then the latest command is set as the reference command (step 1407).

Returning to step 1402, it is examined whether or not the access pattern is continued. If the continuity is not confirmed, it is examined whether or not the command is retrieved N times or more (step 1409). If the command is not retrieved N times or more, the procedure returns to step 1401. Also, it is examined whether or not the command is retrieved N times or more and if the command is retrieved N times or more, the procedure is ended.

As described above, if the read access pattern has the feature as shown in FIG. 11, its feature is extracted and the access area for read-ahead using the latency time is decided based on the feature, whereby the hit ratio of cache can be improved and the data transfer rate can be increased.

Referring to FIG. 14, the control for extracting the access pattern as shown in FIG. 11 will be described below. The control flow of FIG. 14 treats the read command alone. The disk unit registers the access information of the latest N commands (step 1601). The access information means the access start address indicated by the LBA set for each command. In the following, the access distance and the directionality of access are judged based on the access start address indicated by the LBA.

Then, it is examined whether or not there is any command for accessing in the same direction as the registered command (step 1602). If there is no pertinent command group, the procedure returns to step 1601. If there is any pertinent command group, one command of the command group is selected (step 1603). Next, the access distance is measured with the selected command as the start point, and its result is registered (step 1604). It is examined whether or not the distance is measured with all the commands as the start point (step 1605). If the distance is measured with all the commands as the start point, it is examined whether or not there is any command in which a difference in the distance is within several tens sectors (step 1606). If there is any command in which the difference in the distance is within several tens sectors, it is examined whether or not the access pattern in which the difference in the distance is within several tens sectors is repeated Y times or more (step 1607). If the access pattern is repeated Y times or more, the latest command is set as the reference command (step 1608). The reference command means the command as the reference to judge the continuity of the access pattern of object. Then, a representative value of the access distance for this access pattern is saved (step 1609).

Returning to step 1607, if the access pattern is not repeated Y times or more, the process following the step 1601 is repeated. Returning to step 1606. If there is no command in which the distance between commands has a difference within several tens sectors, the process following the step 1601 is repeated. Returning to step 1605, if the distance is not measured with all the commands as the start point, the process following the step 1603 is repeated.

FIG. 15 shows a control flow for judging the continuity of the access pattern extracted in the control flow of FIG. 14. It is examined whether or not the command received after extracting the access pattern is the command for accessing in succession in the same direction (step 1701). If the command is to access in the same direction, it is examined whether or not the distance from the reference command has a difference within several tens sectors from the access distance of the extracted access pattern (step 1702). If the distance from the reference command has a difference within several tens sectors from the access distance of the extracted access pattern, the continuity of access pattern is judged (step 1703), and the procedure is ended. Also, the distance from the reference command does not have a difference within several tens sectors from the access distance of the extracted access pattern, the non-continuity of access pattern is judged (step 1704), and the procedure is ended. Returning to step 1701, it is examined whether or not the command is to access in the same direction in succession. If the command is not to access in the same direction, the non-continuity of access pattern is judged (step 1704), and the procedure is ended.

As described above, with the embodiment of the invention, the read-ahead control for deciding the access area for reading ahead using the latency based on the feature of access pattern makes it possible to improve the hit ratio of cache, and increase the data transfer rate. Especially for the video, a reading process (rewind or fast feed process) for the data written sequentially can be sped up.

This embodiment is also applicable in executing a command queuing. The command queuing is a technique for once putting the received command into a queue, and executing the commands by making the command reordering so that the access time consisting of the seek time and the latency time (the same holds true below) may be shortest. That is, in the command queuing, when a plurality of commands are received, the commands are executed in the reading order of shortening access time, irrespective of the order in which the plurality of command are received.

In the command queuing, the number of commands that can be queued is predetermined, whereby the new command can not be received while the number of commands to be queued is at maximum. However, if the process for commands in the queuing is ended and there is an empty in the queue, the next command can be received at once.

In the read-ahead control of this embodiment, the latency time is allotted to only reading ahead the preceding data, judging that the same access pattern is continued in the execution of succeeding commands, if the access is always made in the minus direction of LBA, as a result of making the command queuing. In the command queuing, since the received command is once queued, the access interval and the directionality of access over the entire command group can be easily analyzed from the LBA information of queued commands.

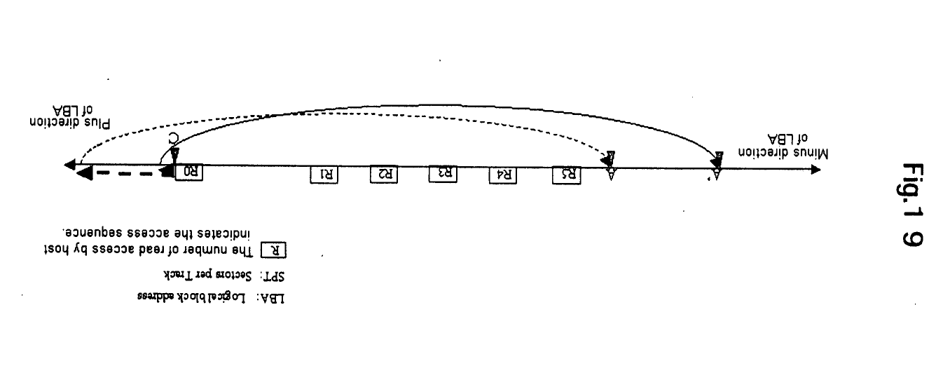

FIG. 18 shows a flow for extracting the access pattern to which the read-ahead control of this embodiment is applied. A counter N for counting the number of extracting the access pattern in the minus direction of LBA is set to 0 (step 1801). Next, it is examined whether or not the seek access to be executed as a result of command reordering is made in the minus direction of LBA (step 1802). If the seek access is made in the minus direction of LBA, it is examined whether or not all the commands in the queue are in the minus position of LBA with respect to the start address of the command performed immediately before the seek (step 1803). If all the commands in the queue are in the minus position of LBA with respect to the start address of the command performed immediately before the seek, the counter N is incremented by one (step 1804).

Next, it is examined whether or not the counter N is greater than the preset value (I) (step 1805). If the counter N is greater than I, the access pattern concerned is extracted (step 1806). At step 1805, if the counter N is not greater than the preset value (I), the procedure returns to step 1802.

At step 1803, if all the commands in the queue are not in the minus position of LBA with respect to the start address of the command performed immediately before the seek, the procedure returns to step 1801.

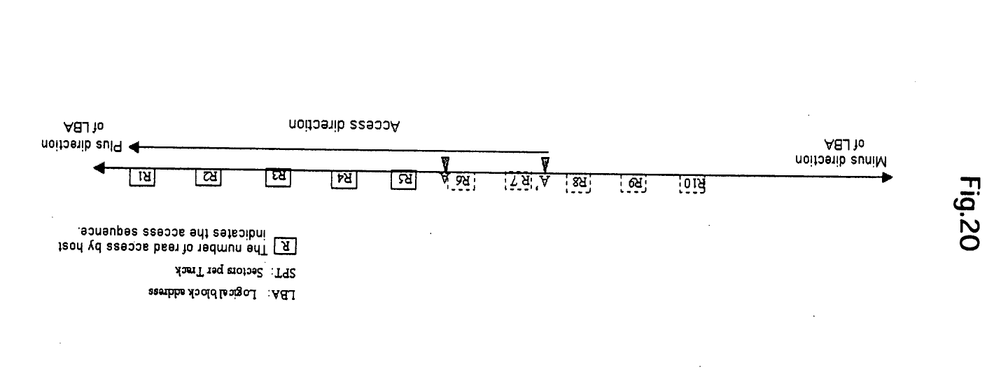

At step 1802, if the seek is not made in the minus direction of LBA, the procedure returns to step 1801. FIG. 19 shows an example of access after extracting the pattern. Herein, the maximum value of command that can be queued is 5. All of R1, R2, R3, R4 and R5 are in the minus position of LBA with respect to the current head position (position C).

By command reordering, the access time is shortest by executing the commands in the order of R5, R4, R3, R2 and R1. If the seek to R5 is performed, all the latency time that occurs is allotted to reading ahead the preceding data for R5 in the read-ahead control of this embodiment. That is, the read-ahead is performed by seeking to the position of A′. In the conventional read-ahead control that was applied before the read-ahead of this embodiment, the read-ahead was performed by seeking to the position A in the drawing. In the example of FIG. 19, an area between A and A′ can be read ahead by applying the read-ahead control of this embodiment.

FIG. 20 shows an example where R6, R7, R8, R9 and R10 are received as the succeeding commands of R1, R2, R3, R4 and R5. If the command pattern occurs as shown in FIG. 20, R6 and R7 are cache hit by reading ahead the area between A and A′, whereby the data transfer efficiency is improved.

In the read-ahead control of this embodiment, the latency time is allotted to only reading ahead the succeeding data, judging that the same access pattern is continued in the execution of the succeeding commands, when the access is always made in the plus direction of LBA, as a result of command queuing.

Though in this embodiment, the process for making the command reordering to minimize the access time has been described, the command reordering may be made in accordance with the level of priority in the execution sequence preset for each command.

While in the above embodiment, only the succeeding data for the preceding command is read ahead (305 of FIG. 1) if the access pattern is the plus pattern and the feature of pattern in the plus direction is continued, the embodiment is not limited thereto, it will be appreciated that more latency time may be allotted to reading ahead the succeeding data for the preceding command than reading ahead the preceding data for the succeeding command. The “more latency time is allotted to reading ahead the succeeding data for the preceding command than reading ahead the preceding data for the succeeding command includes allotting the latency time to only reading ahead the succeeding data for the preceding command. Similarly, while only the preceding data for the succeeding command is read ahead (307 of FIG. 1) if the access pattern is the minus pattern and the feature of pattern in the minus direction is continued, the embodiment is not limited thereto, it will be appreciated that more latency time may be allotted to reading ahead the preceding data for the succeeding command than reading ahead the succeeding data for the preceding command. The “more latency time is allotted to reading ahead the preceding data for the succeeding command than reading ahead the succeeding data for the preceding command includes allotting the latency time to only reading ahead the preceding data for the succeeding command.

In the read-ahead control of the embodiment using the command queuing, the latency time is allotted to only reading ahead the preceding data, judging that the same access pattern is continued in the execution of the succeeding commands, when the access is always made in the minus direction of LBA, as a result of command queuing. However, the embodiment is not limited thereto, it will be appreciated that more latency time may be allotted to reading ahead the preceding data for the succeeding command than reading ahead the succeeding data for the preceding command. The “more latency time is allotted to reading ahead the preceding data for the succeeding command than reading ahead the succeeding data for the preceding command” includes allotting the latency time to only reading ahead the preceding data for the succeeding command. Similarly, in the read-ahead control, the latency time is allotted to only reading ahead the succeeding data, judging that the same access pattern is continued in the execution of the succeeding commands, when the access is always made in the plus direction of LBA, as a result of command queuing. However, the embodiment is not limited thereto, it will be appreciated that more latency time may be allotted to reading ahead the succeeding data for the preceding command than reading ahead the preceding data for the succeeding command. The “more latency time is allotted to reading ahead the succeeding data for the preceding command than reading ahead the preceding data for the succeeding command includes allotting the latency time to only reading ahead the succeeding data for the preceding command.

What is claimed is:

1. A disk unit comprising:
a disk;
a head;
a cache memory;
means for reading the read request data through said head from said disk and transferring it to said cache memory if said read request data is not stored in said cache memory;
preceding data reading ahead means for reading the data stored at an address before said read request data through said head from said disk and transferring it to said cache memory in a disk latency time taken for said head to access said read request data after the end of seeking to the track of said disk in which said read request data is stored;
succeeding data reading ahead means for reading the data stored immediately after the read request data through said head from said disk and transferring it to said cache memory after transferring said read request data to said cache memory;
latency time prediction means for predicting a latency time that occurs in accessing the read request data for a succeeding command by interrupting the read-ahead for the succeeding data if it is required for the succeeding command to transfer the read request data to said cache memory while said succeeding data reading ahead means is executing the read-ahead; and
means for allotting the latency time predicted by said latency time prediction means to said succeeding data reading ahead means and said preceding data reading ahead means based on the feature of an access pattern in a command group immediately before the latency occurs.

2. The disk unit according to claim 1, characterized in that the access pattern and its feature are extracted by analyzing an access direction and an access interval in terms of the logical block address (LBA) designated by the read command.

3. The disk unit according to claim 2, characterized in that if the start address (LBA) of the read request data for the received read command is greater than the start address (LBA) of the read request data for the directly previous read command by comparing the start address (LBA) of the read request data for the received read command with the start address (LBA) of the read request data for the directly previous read command, it is judged that the access is made in the plus direction of LBA, or if the start address (LBA) of the read request data for the received read command is smaller than the start address (LBA) of the read request data for the directly previous read command, it is judged that the access is made in the minus direction of LBA, in which the access interval is analyzed by calculating the distance between the start address (LBA) of the read request data for the received read command and the start address (LBA) of the read request data for the directly previous read command.

4. The disk unit according to claim 3, characterized in that if there is a feature of pattern with the plus direction of LBA in the directly previous command group and the pattern for accessing in the plus direction of LBA is continued in the succeeding command, more latency time predicted by said latency time prediction means is allotted to said succeeding data reading ahead means than said preceding data reading ahead means, or if there is a feature of pattern with the minus direction of LBA in the directly previous command group and the pattern for accessing in the minus direction of LBA is continued in the succeeding command, more latency time predicted by said latency time prediction means is allotted to said preceding data reading ahead means than said succeeding data reading ahead means.

5. The disk unit according to claim 4, characterized in that in the case where the access distance between commands in the pattern in which the access to each command is made in the plus direction or minus direction of LBA is within an accessible distance using the latency time, if the pattern in the succeeding command is to access in the plus direction of LBA, more latency time predicted by said latency time prediction means is allotted to said succeeding data reading ahead means than said preceding data reading ahead means, or if the pattern in the succeeding command is to access in the minus direction of LBA, more latency time predicted by said latency time prediction means is allotted to said preceding data reading ahead means than said succeeding data reading ahead means.

6. The disk unit according to claim 4, characterized by comprising means for predicting an access area of the succeeding command from the directionality of access and the access interval between commands if the access distance between commands for any of the patterns where the access to each command is made in the plus direction or minus direction of LBA is a definite distance interval, in which if the access time to the read request data (time required to access the read request data from the current head position) is longer than the access time to said predicted area, the read request data is read after said predicted area is accessed and the read-ahead of said predicted area is executed.

7. The disk unit according to claim 6, characterized in that the command group with the same access direction is extracted from the latest N commands, and the command group in which there is a difference within several tens sectors in the access distance is further extracted by investigating the access distance between commands in the command group with the same access direction, wherein the latest command in said command group is set as the reference command, a representative value of the access distance where there is a difference within several tens sectors is saved, and the pattern with the same access direction and the approximate access distance is extracted.

8. The disk unit according to claim 7, characterized in that if the access to the succeeding command as compared with the reference command has the access direction equal to the saved access direction and the access distance approximate to the saved access distance after extracting said access pattern, it is judged that said access pattern is continued.

9. The disk unit according to claim 1, characterized in that said each means is realized by a processor executing a micro-program.

10. A disk unit comprising:
a disk for holding data;
a head for recording or reading data onto or from said disk;
a cache memory for storing data read from said disk; and
a control unit for reading the read request data through said head from said disk and transferring it to said cache memory if said read request data is not stored in said cache memory;
wherein said control unit reads ahead the succeeding data by reading data recorded after the read request data through said head from said disk and transferring it to said cache memory after transferring the read request data to said cache memory; and
reads ahead the preceding data by reading data recorded at an address before said read request data through said head from said disk and transferring it to said cache memory in a disk latency time taken for said head to access said read request data after the end of seeking to a track of said disk where said read request data is recorded;
predicts the latency time that occurs in accessing the read request data for the succeeding command by interrupting the read-ahead for the succeeding data if it is required for the succeeding command to transfer the read request data to said cache memory while executing the read-ahead of said succeeding data; and
allots the predicted latency time to reading ahead said succeeding data and reading ahead said preceding data based on the feature of an access pattern in the command group immediately before the latency occurs.

11. The disk unit according to claim 10, characterized in that the access pattern and its feature are extracted by analyzing an access direction and an access interval in terms of the logical block address (LBA) designated by the read command.

12. The disk unit according to claim 11, characterized in that if the start address (LBA) of the read request data for the received read command is greater than the start address (LBA) of the read request data for the directly previous read command by comparing the start address (LBA) of the read request data for the received read command with the start address (LBA) of the read request data for the directly previous read command, it is judged that the access is made in the plus direction of LBA, or if the start address (LBA) of the read request data for the received read command is smaller than the start address (LBA) of the read request data for the directly previous read command, it is judged that the access is made in the minus direction of LBA, in which the access interval is analyzed by calculating the distance between the start address (LBA) of the read request data for the received read command and the start address (LBA) of the read request data for the directly previous read command.

13. The disk unit according to claim 12, characterized in that if there is a feature of pattern with the plus direction of logical block address (LBA) in the command group immediately before the latency occurs and the pattern for accessing in the plus direction of LBA is continued in the succeeding command, more said predicted latency time is allotted to reading a head said succeeding data than reading ahead said preceding data, or if there is a feature of pattern with the minus direction of LBA in the command group immediately before and the pattern for accessing in the minus direction of LBA is continued in the succeeding command, more said predicted latency time is allotted to reading ahead said preceding data than reading ahead said succeeding data.

14. A read-ahead control method for a rotation type storage device having a cache memory, the method comprising:
a succeeding data reading ahead step of reading the read request data through a head from the rotation type recording medium and transferring it to said cache memory, and then reading data recorded after said read request data from said recording medium and transferring it to said cache memory, if said read request data is not stored in said cache memory; and
a preceding data reading ahead step of reading data recorded at an address before said read request data through said head from said recording medium and transferring it to said cache memory in a latency time taken for said head to access the read request data after the end of seeking to an area of said recording medium where said read request data is recorded;
wherein if it is required for the succeeding command to transfer the read request data to said cache memory during the execution of reading ahead the succeeding data, the method includes interrupting the read-ahead for the succeeding data, predicting the latency time that occurs in accessing the read request data for the succeeding command, and allotting the predicted latency time to said succeeding data reading ahead step and said preceding data reading ahead step based on the feature of an access pattern in the command group before the latency occurs.

15. The read-ahead control method for the rotation type storage device according to claim 14, characterized in that the access pattern and its feature are extracted by analyzing an access direction and an access interval in terms of the logical block address (LBA) designated by the read command.

16. The read-ahead control method for the rotation type storage device according to claim 15, characterized in that if the start address (LBA) of the read request data for the received read command is greater than the start address (LBA) of the read request data for the directly previous read command by comparing the start address (LBA) of the read request data for the received read command with the start address (LBA) of the read request data for the directly previous read command, it is judged that the access is made in the plus direction of LBA, or if the start address (LBA) of the read request data for the received read command is smaller than the start address (LBA) of the read request data for the directly previous read command, it is judged that the access is made in the minus direction of LBA, in which the access interval is analyzed by calculating the distance between the start address (LBA) of the read request data for the received read command and the start address (LBA) of the read request data for the directly previous read command.

17. The read-ahead control method for the rotation type storage device according to claim 16, characterized in that if there is a feature of pattern with the plus direction of LBA in the directly previous command group and the pattern for accessing in the plus direction of LBA is continued in the succeeding command, more said predicted latency time is allotted to said succeeding data reading ahead step than said preceding data reading ahead step, or if there is a feature of pattern with the minus direction of LBA in the directly previous command group and the pattern for accessing in the minus direction of LBA is continued in the succeeding command, more said predicted latency time is allotted to said preceding data reading ahead step than said succeeding data reading ahead step.

18. The read-ahead control method for the rotation type storage device according to claim 17, characterized in that in the case where the access distance between commands in the pattern in which the access to each command is made in the plus direction or minus direction of LBA is within an accessible distance using the latency time, if the pattern in the succeeding command is to access in the plus direction of LBA, more said predicted latency time is allotted to said succeeding data reading ahead step than said preceding data reading ahead step, or if the pattern in the succeeding command is to access in the minus direction of LBA, more said predicted latency time is allotted to said preceding data reading ahead step than said succeeding data reading ahead step.

19. The read-ahead control method for the rotation type storage device according to claim 17, characterized by further including a step of predicting an access area of the succeeding command from the directionality of access and the access interval between commands if the access distance between commands for any of the patterns in which the access to each command is made in the plus direction or minus direction of LBA is a definite distance interval, wherein if the access time to the read request data is longer than the access time to said predicted area (the time taken for accessing from the current head position to the predicted area and further accessing the read request data), the read request data is read after the read-ahead for said predicted area is executed by accessing said predicted area.

20. The read-ahead control method for the rotation type storage device according to claim 19, characterized in that the command group with the same access direction is extracted from the latest N commands, and the command group in which there is a difference within several tens sectors in the access distance is further extracted by investigating the access distance between commands in the command group with the same access direction, wherein the latest command in said command group is set as the reference command, a representative value of the access distance where there is a difference within several tens sectors is saved, and the pattern with the same access direction and the approximate access distance is extracted.

21. The disk unit according to claim 1, characterized in that the access pattern is extracted by analyzing the access direction in terms of the logical block address (LBA) designated by the read command, said disk unit comprising means for executing the commands in the order irrespective of the order in which a plurality of commands are received when said plurality of commands are received, wherein if the start address (LBA) of the read request data for the command being executed is greater than the start address (LBA) of the read request data for said plurality of received read commands, more latency time predicted by said latency time prediction means is allotted to said preceding data reading ahead means than said succeeding data reading ahead means, or if the start address (LBA) of the read request data for the command being executed is smaller than the start address (LBA) of the read request data for said plurality of received commands, more latency time predicted by said latency time prediction means is allotted to said succeeding data reading ahead means than said preceding data reading ahead means.

22. The disk unit according to claim 10, characterized in that the access pattern is extracted by analyzing the access direction in terms of the logical block address (LBA) designated by the read command, said control unit executes the commands in the order irrespective of the order in which the plurality of commands are received if said plurality of commands are received, in which if the start address (LBA) of read request data for the command being executed is greater than the start address (LBA) of the read request data for said plurality of received commands, said control unit allots more latency time predicted by said latency time prediction means to said preceding data reading ahead means than said succeeding data reading ahead means, and if the start address (LBA) of read request data for the command being executed is smaller than the start address (LBA) of the read request data for said plurality of received commands, said control unit allots more latency time predicted by said latency time prediction means to said succeeding data reading ahead means than said preceding data reading ahead means.

23. The read-ahead control method for the rotation type storage device according to claim 14, characterized in that the access pattern is extracted by analyzing the access direction in terms of the logical block address (LBA) designated by the read command, said method including a command execution step of executing the commands in the order irrespective of the order in which a plurality of commands are received when said plurality of commands are received, wherein if the start address (LBA) of the read request data for the command being executed is greater than the start address (LBA) of the read request data for said plurality of received commands, more said predicted latency time is allotted to said preceding data reading ahead step than said succeeding data reading ahead step, or if the start address (LBA) of the read request data for the command being executed is smaller than the start address (LBA) of the read request data for said plurality of received read commands, more said predicted latency time is allotted to said succeeding data reading ahead step than said preceding data reading ahead step.
